(19) United States
(12) Patent Application Publication
(10) Pub. No.: US 2008/0165120 A1
(43) Pub. Date: Jul. 10, 2008

(54) Passive Matrix Electrophoretic Display with Reset

(75) Inventor: Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/720,525

(22) PCT Filed: Nov. 29, 2005
(86) PCT No.: PCT/IB05/53940

§ 371 Date: May 31, 2007

(30) Foreign Application Priority Data
Dec. 6, 2004 (EP) 04106316.5

(51) Int. Cl. G09G 3/34

(52) U.S. Cl. 345/107

(57) ABSTRACT

A passive matrix electrophoretic display (1) in which a select driver applies a select waveform to each line of the matrix and a data driver applies a sequence of drive signals (D) to the columns of the matrix according to the image to be displayed on the device. The select waveform includes a reset signal (R1,Rn) which precedes a select signal (S) to be applied to the picture elements of a line of the matrix. The reset signals (R1) may be applied substantially simultaneously to at least a subset of lines of matrix, before respective drive signals (D) are applied to the pixels (2) thereof. Alternatively a select waveform (including the reset signal (RN)) may be applied to each line of the matrix sequentially, with the drive signals (D) being applied to the pixels (2) of each selected line of the matrix whilst the next line is being reset. As a result, the image update line of the device (1) is reduced.

This invention relates to an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, and drive means arranged to supply a sequence of drive signals to said electrodes, each drive signal causing said particles to occupy a predetermined optical state corresponding to image information to be displayed.

An electrophoretic display comprises an electrophoretic medium consisting of charged particles in a fluid, a plurality of picture elements (pixels) arranged in a matrix, first and second electrodes associated with each pixel, and a voltage driver for applying a potential difference to the electrodes of each pixel to cause the charged particles to occupy a position between the electrodes, depending on the value and duration of the applied potential difference, so as to display a picture.

In more detail, an electrophoretic display device is a matrix display with a matrix of pixels which are associated with intersections of crossing data electrodes and select electrodes. A grey level, or level of colorization of a pixel, depends on the time a drive voltage of a particular level is present across the pixel. This is also referred to as the energy (=voltage×time) applied to the pixel. Dependent on the polarity of the drive voltage, the optical state of the pixel changes from its present optical state continuously towards one of the two limit situations (i.e. extreme optical states), e.g. one type of charged particles is near the top or near the bottom of the pixel. Intermediate optical states, e.g. greyscales in a black and white display, are obtained by controlling the time the voltage is present across the pixel.

Usually, all of the pixels are selected line-by-line by supplying appropriate voltages to the select electrodes. The data is supplied in parallel via the data electrodes to the pixels associated with the selected line.

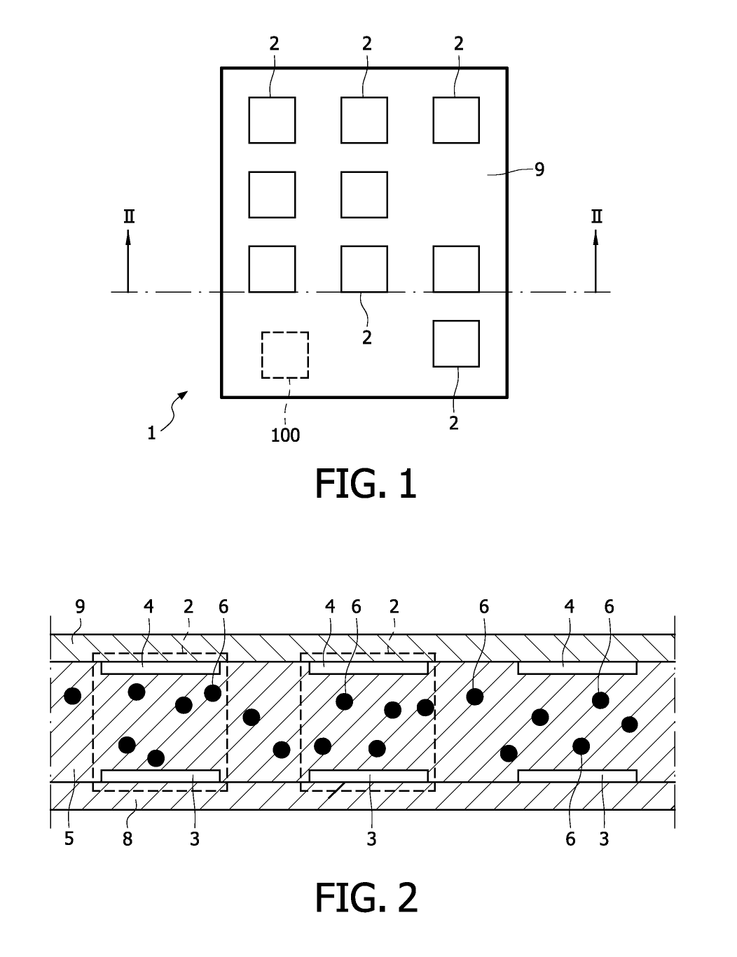

FIGS. 1 and 2 illustrate an exemplary embodiment of a display panel 1 having a first substrate 8, a second opposed substrate 9, and a plurality of picture elements 2. In one embodiment, the picture elements 2 might be arranged along substantially straight lines in a two-dimensional structure.

An electrophoretic medium 5, having charged particles 6 in a fluid, is present between the substrates 8, 9. A first and second electrode 3, 4 are associated with each picture element 2 for receiving a potential difference. In the arrangement illustrated in FIG. 2, the first substrate 8 has for each picture element 2 a first electrode 3, and the second substrate 9 has for each picture element 2 a second electrode 4, but alternatively, both electrodes could be situated on the same substrate, being laterally spaced in order to create an electrical field in the plane of the substrate. The charged particles 6 are able to occupy extreme positions near the electrodes 3, 4, and intermediate positions between the electrodes 3, 4. Each picture element 2 has an appearance determined by the position of the charged particles 6 between the electrodes 3, 4.

Electrophoretic media are known per se from, for example, U.S. Pat. No. 5,961,804, U.S. Pat. No. 6,120,839 and U.S. Pat. No. 6,130,774, and can be obtained from, for example, E-Ink Corporation. As an example, the electrophoretic medium 5 might comprise negatively charged black particles 6 in a white fluid. When the charged particles 6 are in a first extreme position, i.e. near the first electrode 3, as a result of potential difference applied to the electrodes 3, 4 of, for example, 15 Volts, the appearance of the picture element 2 is for example, white in the case that the picture element 2 is observed from the side of the second substrate 9.

When the charged particles 6 are in a second extreme position, i.e. near the second electrode 4, as a result of a potential difference applied to the electrodes 3, 4 of, for example, −15 Volts, the appearance of the picture element is black. When the charged particles 6 are in one of the intermediate positions, i.e. between the electrodes 3, 4, the picture element 2 has one of a plurality of intermediate appearances, for example, light grey, mid-grey and dark grey, which are grey levels between black and white.

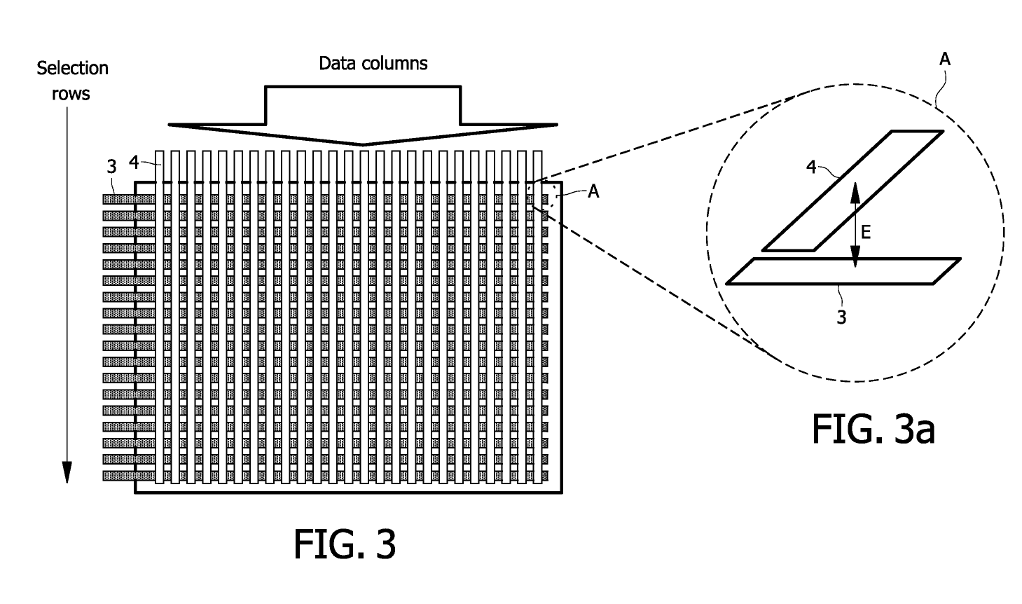

In typical passive matrix addressing, the drive signals are introduced to the display, typically sequentially by scanning the pixels one line at a time along the (orthogonal) selection rows and data columns, as illustrated in FIG. 3 of the drawings. A row driver (not shown) supplies an appropriate select pulse to the bottom electrode 3 of a line to be addressed whilst a data voltage is supplied at the column electrodes 4 to be supplied to the pixels. The pixel voltage is the difference between the select voltage and the data voltage.

The drive signals generate perpendicular electric fields E between the top electrodes 4 and the bottom electrodes 3, as illustrated in the detail of FIG. 3a, and the drive voltages applied to a pixel may be positive, negative or zero, depending on the change in optical state, i.e. the image transition, required to be effected. In this case a zero voltage is usually applied if no image transition (i.e. no change in optical state) is required to be effected.

Once a line is no longer being addressed, the electrical field between the top and bottom electrodes 4, 3 of that line is reduced to a level whereby the particles will not move, for example, by reducing the field E to a level below a threshold voltage for motion intrinsic to the particle system being driven, or a threshold otherwise introduced by adding an electrical field barrier using a further electrode in the pixel. As a concequence, the particles only move when a line is being addressed, and it takes a relatively long time to complete addressing the display (in general, the response speed of the pixel times the number of rows in the display) each time a new image is required to be displayed.

US Patent Application Publication No. US2003/0081305 A1 describes an electrophoretic display which employs a passive matrix driving scheme, as described above, whereby each time a new image is required to be displayed, the display is updated one row at a time with the pixels of the row being addressed being updated whilst the pixels of the other rows remain unchanged. In order to maximise the quality of the new image and, in particular, to limit the amount of image retention therein, it is advantageous to introduce a reset into the driving scheme and, in the arrangement of US 2003/0081305, during an image update, all of the pixels of each row are first reset to a state wherein the charged particles are at or near one of the extreme optical states of the display (i.e. black or white in a monochrome display), following which, the pixels of the line being addressed are then driven to the desired optical states.

In general, however, the reset portion of a drive scheme lasts considerably longer than the driving portion. Consequently, in the prior art arrangement described above where the driving signals (including the reset portion) are applied to the display sequentially, one line at a time, a significant delay is introduced while each line is reset before the drive portion of the signal is applied, and the result is unacceptably long image update times.

It is therefore an object of the present invention to provide a passive matrix electrophoretic display, and method of driving same, having a reduced image update time whilst still maintaining a reset function.

Thus, in accordance with a first aspect of the present invention, there is provided an electrophoretic display device comprising an electrophoretic material comprising charged particles in a fluid, a plurality of sets of picture elements, first and second electrodes associated with each picture element, the charged particles being able to occupy a position being one of a plurality of positions between said electrodes, said positions corresponding to respective optical states including at least first and second extreme optical states, the device further comprising drive means arranged to supply a sequence of drive signals to said electrodes, each drive signal causing said particles to occupy a predetermined optical state corresponding to image information to be displayed, the device further comprising means for updating an image displayed on said device by:
a) substantially simultaneously applying a reset signal to each of a plurality of said sets of picture elements, each reset signal causing said particles to occupy one of said extreme optical states;
b) sequentially selecting one or more picture elements of said sets of picture elements to which a reset signal has been applied, and applying thereto a drive signal.

Thus, because a reset signal is applied substantially simultaneously to at least a sub-set of the row electrodes (referring to the embodiment described above), the image update time is reduced relative to the prior art.

The drive means preferably comprises passive drive means and the device is preferably a passive matrix display device.

In a first exemplary embodiment, a reset signal may be substantially simultaneously applied to all of the sets of picture elements, i.e. in the case where the picture elements are arranged in a matrix or array, a reset signal may be substantially simultaneously applied to each row or column of picture elements of the display device.

In accordance with a second aspect of the present invention, there is provided an electrophoretic display device comprising an electrophoretic material comprising charged particles in a fluid, a plurality of sets of picture elements, first and second electrodes associated with each picture element, the charged particles being able to occupy a position being one of a plurality of positions between said electrodes, said positions corresponding to respective optical states including at least first and second extreme optical states, the device further comprising drive means arranged to supply a sequence of drive signals to said electrodes, each drive signal causing said particles to occupy a predetermined optical state corresponding to image information to be displayed, and select means for applying a select signal to a set of picture elements to which said drive signals are to be applied, wherein, in order to update an image displayed on said device, said select means is arranged to apply a reset signal to one or more of said sets of picture elements prior to applying a respective select signal thereto, each reset signal causing said particles to occupy one of said extreme optical states.

Thus, because the drive and reset functions are provided and applied separately, some sets (i.e. lines in the example illustrated above) of picture elements can be data driven, whilst others are being reset, thereby once again reducing the image update time relative to the prior art.

In a first exemplary embodiment, all of the sets (or lines) of (at least) a subset of picture elements may be reset substantially simultaneously, following which, the reset sets of picture elements may be sequentially selected. Alternatively, a reset signal and select signal may be sequentially applied to each set of picture elements, with drive signals being sequentially applied to each respective set of picture elements to which a select signal has been applied whilst a reset signal is being applied to the other sets of picture elements in the sequence. In either case, drive signals are applied to one or more of the sets of picture elements whilst one or more other sets of pixels are being reset.

The first aspect of the present invention extends to a method of driving an electrophoretic display device comprising an electrophoretic material comprising charged particles in a fluid, a plurality of sets of picture elements, first and second electrodes associated with each picture element, the charged particles being able to occupy a position being one of a plurality of positions between said electrodes, said positions corresponding to respective optical states including at least first and second extreme optical states, the method comprising supplying a sequence of drive signals to said electrodes, each drive signal causing said particles to occupy a predetermined optical state corresponding to image information to be displayed, the method further comprising updating an image displayed on said device by:
a) substantially simultaneously applying a reset signal to each of a plurality of said sets of picture elements, each reset signal causing said particles to occupy one of said extreme optical states;
b) sequentially selecting one or more picture elements of said sets of picture elements to which a reset signal has been applied, and applying thereto a drive signal.

The first aspect of the present invention further extends to a drive means for driving an electrophoretic display device as defined above, wherein the drive means is arranged to supply a sequence of drive signals to said electrodes, each drive signal causing said particles to occupy a predetermined optical state corresponding to image information to be displayed and means for updating an image displayed on said device by:
a) substantially simultaneously applying a reset signal to each of a plurality of said sets of picture elements, each reset signal causing said particles to occupy one of said extreme optical states;
b) sequentially selecting one or more picture elements of said sets of picture elements to which a reset signal has been applied, and applying thereto a drive signal.

The second aspect of the present invention extends to a method of driving an electrophoretic display device comprising an electrophoretic material comprising charged particles in a fluid, a plurality of sets of picture elements, first and second electrodes associated with each picture element, the charged particles being able to occupy a position being one of a plurality of positions between said electrodes, said positions corresponding to respective optical states including at least first and second extreme optical states, the method comprising supplying a sequence of drive signals to said electrodes, each drive signal causing said particles to occupy a predetermined optical state corresponding to image information to be displayed, and applying a select waveform including a select signal to a set of picture elements to which said drive signals are to be applied, wherein, said select waveform further includes a reset signal to be applied to one or more of said sets of picture elements prior to applying a respective select signal thereto, each reset signal causing said particles to occupy one of said extreme optical states.

The second aspect of the present invention further extends to a drive means for driving an electrophoretic display device as defined above, the drive means comprising a data driver for supplying a sequence of drive signals to said electrodes, each drive signal causing said particles to occupy a predetermined optical state corresponding to image information to be displayed, and a select driver for applying a select waveform including a select signal to a set of picture elements to which said drive signals are to be applied, wherein said select waveform further includes a reset signal to be applied to one or more of said sets of picture elements prior to applying a respective select signal thereto, each reset signal causing said particles to occupy one of said extreme optical states.

Preferably, in respect of both the first and second aspects of the present invention, the reset signal comprises a voltage which is at least substantially equal to the highest voltage achievable across a respective picture element. In one exemplary embodiment, the preferred reset voltage is preferably substantially equal to the voltage difference between a drive (or data) signal and a select signal. As a result of this, the reset function can be carried in the fastest possible time.

In a preferred embodiment, the device comprises a third electrode associated with each picture element, which third electrode is preferably arranged to prohibit motion of the particles in non-selected picture elements.

Preferably, each reset signal causes said particles to occupy the same extreme optical state in respect of all of the picture elements of said display, as a result of which the select voltage can be optimised for the entire display.

In one exemplary embodiment, each reset signal may comprise a plurality of pulses of alternately opposing polarities, so as to drive the respective picture element successively between the extreme optical states. In this case, the corresponding data and select signals preferably alternate between their maximum and minimum values so as to ensure that the reset to both extreme optical states is carried out at a maximum picture element voltage. The final pulse of the reset signal may be longer and/or have a larger voltage than the preceding pulses of the reset signal, so as to ensure that the particles are well over-reset (and hence in a well-defined extreme state), prior to the application of the drive signals. Alternatively, or in addition, the application of drive signals to the display may be halted during application of the final pulse of the reset signal, so as to ensure that the respective particles are reset in a well-defined manner.

In all cases, the magnitude and/or duration of the reset voltage is preferably greater than the maximum voltage required to drive all of said particles to said extreme optical state, as such an over-reset is useful in reducing image retention.

These and other aspects of the present invention will be apparent from, and elucidated with reference to, the embodiments described herein.

Embodiments of the present invention will now be described by way of examples only and with reference to the accompanying drawings, in which:

FIG. 1 is a schematic front view of an electrophoretic display panel;

FIG. 2 is a schematic cross-sectional view along II-II of FIG. 1;

FIG. 3 is a schematic illustration of a typical passive matrix display layout for generating perpendicular electric fields between the top and bottom electrodes;

FIG. 3a is the illustrated detail A of FIG. 3;

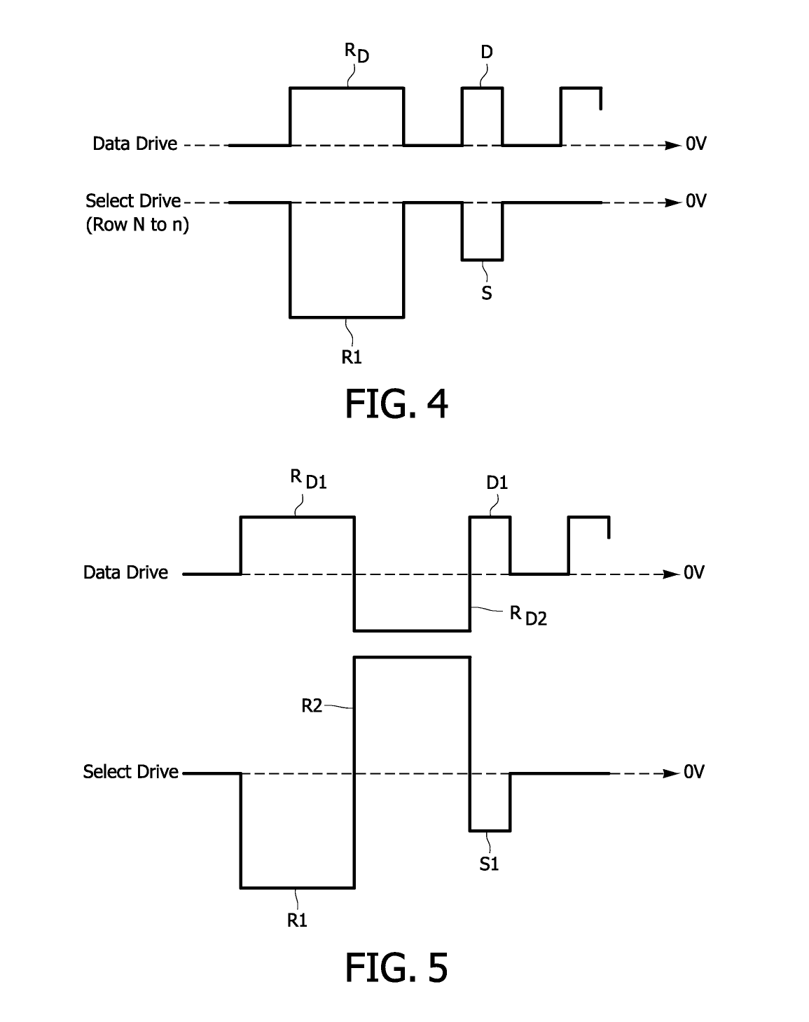

FIG. 4 illustrates representative drive and select waveforms in respect of an electrophoretic display according to a first exemplary embodiment of the present invention;

FIG. 5 illustrates representative drive and select waveforms in respect of an electrophoretic display according to a second exemplary embodiment of the present invention;

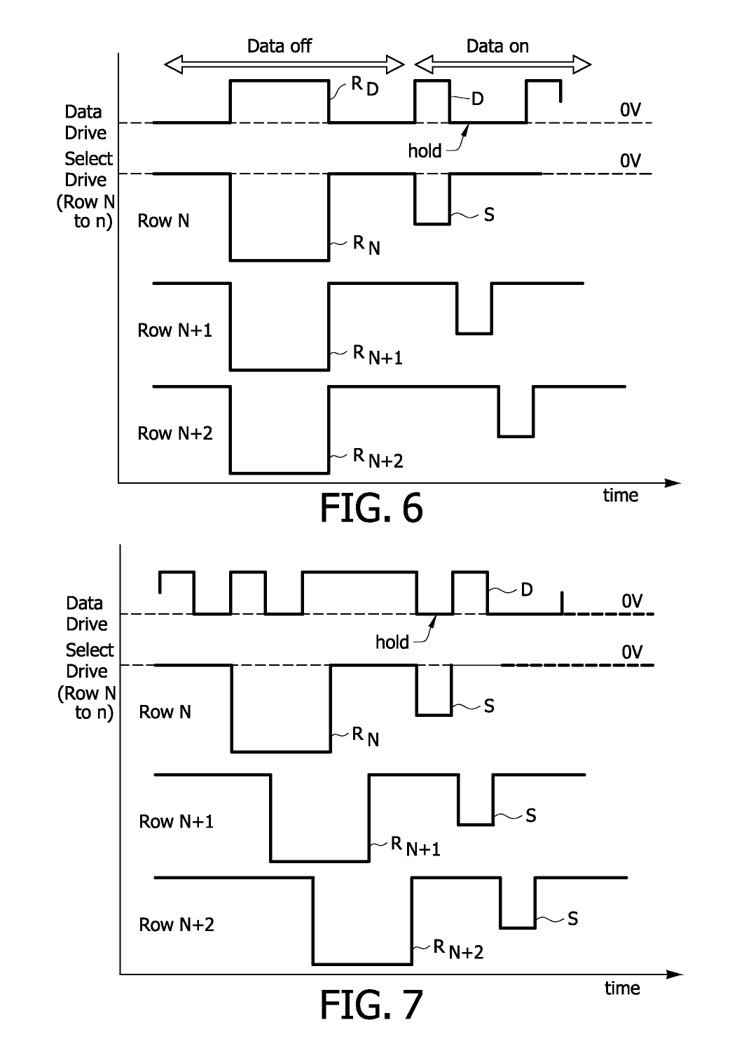

FIG. 6 illustrates representative drive and select waveforms in respect of an electrophoretic display according to a third exemplary embodiment of the present invention;

FIG. 7 illustrates representative drive and select waveforms in respect of an electrophoretic display according to a fourth exemplary embodiment of the present invention;

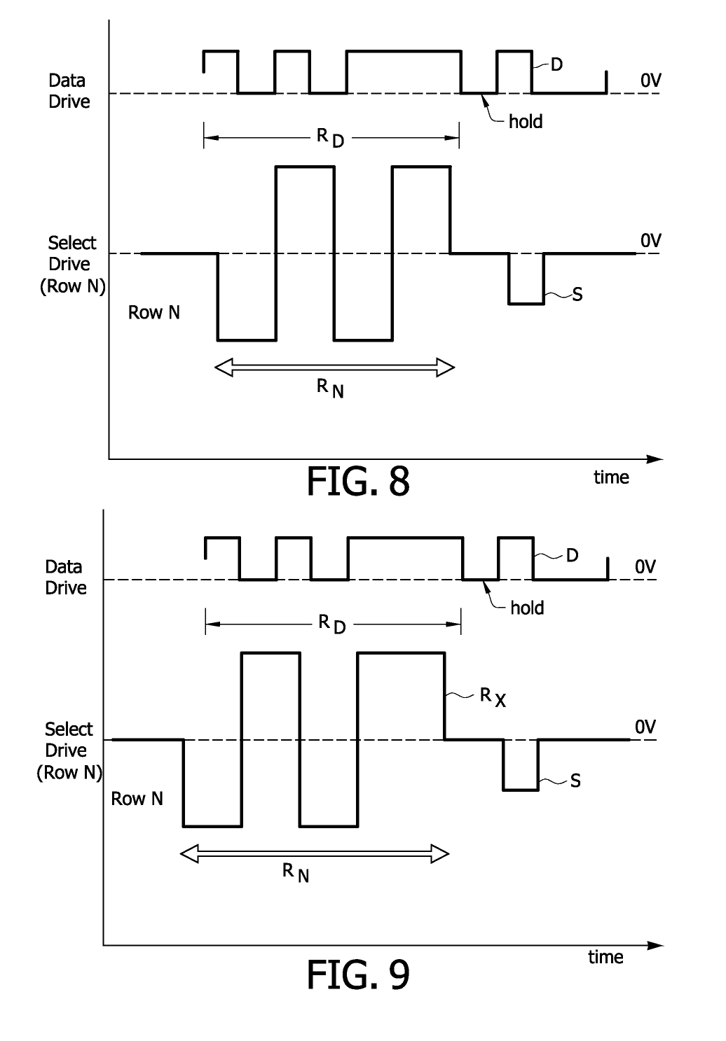

FIG. 8 illustrates representative drive and select waveforms in respect of an electrophoretic display according to a fifth exemplary embodiment of the present invention; and

FIG. 9 illustrates representative drive and select waveforms in respect of an electrophoretic display according to a sixth exemplary embodiment of the present invention.

In accordance with a first exemplary embodiment of the present invention, one method of reducing the total image update time for a passive matrix display is to introduce a complete reset of the display prior to writing the new image. Such a reset can be realised, referring to FIG. 4 of the drawings, by activating all select lines of the passive matrix simultaneously, and applying the same reset voltage R1 to all data lines. During this phase, the data drivers are set to a (data independent) voltage R_{D} to maximise pixel voltage during resetting. Thus, all of the rows of the matrix are reset substantially simultaneously.

The reset may be to any defined pattern, providing that all pixels in the display are reset to one of the extreme optical states. Examples of reset patterns are a fully white or fully black screen, but also patterns with alternating data lines set to black and white stripe patterns (whereby the display will appear to be a mid-grey colour when seen from a normal viewing distance).

In general, a reset voltage should be sufficient to drive a respective pixel to one of the extreme optical states, irrespective of the optical state of that pixel at the time when the reset voltage is applied. For example, the reset voltage should (at least) be sufficient to drive a pixel in, say, a fully white state to a fully black reset state (in a monochrome display). Preferably, the reset voltage R1 is set at the highest possible voltage achievable across the pixel in this case given as the difference between data voltage D and select voltage S. This ensures that the reset is carried out as quickly as possible. For this reason, it is preferred to reset the entire matrix to either a fully white or a fully black screen, as resetting alternate lines towards the two extreme optical states simultaneously results in a reduced resetting voltage (as the select voltage cannot be optimised for both reset driving polarities simultaneously).

In another embodiment, a reset may be realised by setting all select electrodes to a non-select voltage and providing a reset signal to the data electrodes that exceeds the threshold voltage for moving the particles. The reset signal will, in general, exceed in magnitude the normal data signals.

In another exemplary embodiment, referring to FIG. 5 of the drawings, the reset can involve a series of reset signals, driving the entire display successively between the extreme optical states e.g. black (Reset 1)-white (Reset 2)—black-white. Preferably, both data (D) and select (S) voltages will alternate between their maximum and minimum values to ensure that both the reset to black and the reset to white are carried out at a maximum pixel voltage, as shown in FIG. 5.

In both embodiments as described above with reference respectively to FIGS. 4 and 5 of the drawings, after the reset is completed, the next image is introduced, one line at a time, making use of only the shorter driving pulses D. This will result in a faster image update relative to the prior art arrangement described above.

One issue relating to the universal reset described with reference to FIGS. 4 and 5 of the drawings, is that the previous image is immediately fully erased, and the new image only relatively slowly built up (i.e. one line at a time). This means that, for a considerable period of time, a sign comprising an electrophoretic display according to this exemplary embodiment of the invention will not show any information. In some circumstances at least, for example, if advertising is being charged per time slot, this is a considerable disadvantage.

One method of ensuring that a display continues to show information whilst still reducing the total image update time for a passive matrix display is to introduce a scanning reset of the display. In this case, the previous image can be made to change smoothly into the new image by scrolling the reset and driving pulses across the display.

Such a scanning reset is achieved in standard passive matrix addressing (as described in, for example, US2003/0081305 referred to above) by introducing the reset driving waveforms (reset+drive portions) to the select lines of the display sequentially, one line at a time. However, as explained above, it is necessary, as a result of this driving scheme, to wait until each line has been reset before the driving signals for the new image can be introduced, which in turn results in a relatively very slow image update process.

In a further exemplary embodiment of the present invention, it is therefore proposed to apply a reset to a subset of the select lines of the passive matrix substantially simultaneously. In this manner, it is possible to introduce the required scanning reset, whilst considerably reducing the image update time relative to prior art arrangements.

Thus, in a third exemplary embodiment of the present invention, it is proposed to completely separate the scanning reset and data driving portions of the image update, as illustrated schematically in FIG. 6 of the drawings. In this case, image update proceeds as follows:
A reset voltage (R_{N}, R_{N+1}, R_{N+2}, . . . , R_{M}) is applied to a subset M of the select lines until all pixels have reached one of the extreme optical states. During this phase, the data drivers are set to a (data independent) voltage R_{D}, as before, to maximise the pixel voltage during resetting. These select lines (R_{N}, R_{N+1}, R_{N+2}, . . . , R_{M}) are thus reset simultaneously.
A new image is written to the same subset of the select lines by selecting these lines one at a time and applying the driving voltages D in the normal manner.

The image update time is now reduced relative to the prior art, by an amount which is dependent on the number of lines that are reset simultaneously.

In a fourth exemplary embodiment, it is proposed to (at least partially) combine the scanning reset and data driving portions of the image update, i.e. one or more lines may be having drive voltages applied thereto whilst others are being reset in preparation for being data driven. Addressing can either be carried out line at a time, or with a subset of select lines being reset at the same point in time. In either case, image update proceeds as follows:
1. The data drivers operate throughout the image update period, applying data signals continuously to the data lines.
2. Each line select now consists of a reset portion (R_{N}, R_{N+1}, R_{N+2}, . . . , Rₙ) followed by a select portion S, as illustrated schematically in FIG. 7 of the drawings.
3. The reset voltage (R_{N}, R_{N+1}, R_{N+2}, . . . , Rₙ) is chosen to be so high that, in combination with the (unknown) data signal D, the pixel voltage remains of the same polarity and at a level exceeding the pixel threshold voltage.
4. The reset is applied to (a subset M of) the select lines (N, N+1, N+2, . . . , M) until all pixels have reached one of the extreme optical states.
5. In the order to guarantee that all the pixels in the line are reset, the image reset time is ideally chosen so that those pixels which have the lowest possible voltage (i.e. with the data voltage closest to the reset voltage) can reach the reset position. As a result, all other pixels will receive a harder reset than is necessary to reach the extreme position. This represents an over-reset situation, but is not damaging, as the particles will no longer move once the extreme position is reached. In fact, it has been observed that a certain amount of over-reset helps in reducing image retention, so it may be advantageous to increase the reset period will be beyond even that defined above.
6. After completion of the reset, a lower select voltage S is applied to the select line and a new image is written to the selected line by applying the driving voltages D (data voltages) during the select period. Note that these data pulses will be present as the following lines in the display are being reset.
7. After selection, the select signal S is returned to the non-select level.

Within this embodiment, it is also possible to provide repeated resets to black-white-black-white etc. by extending the reset portion R_{N}, as shown in FIG. 8 of the drawings. This has the advantage of reducing the amount of image retention in the image.

In yet another exemplary embodiment of the present invention, with reference to FIG. 9 of the drawings, the final reset pulse R_{X} of the reset portion R_{N} is made stronger (i.e. with a longer and/or higher voltage) than the preceding portions. This ensures that the particles are well over-reset (and hence in a well-defined extreme state) before the data driving pulses D are applied.

In yet another embodiment, the data signals may be stopped during application of the final reset pulse R_{X}. This ensures that the particles are reset in a well defined manner. Thus, the final reset pulse R_{X} (and associated driving) proceeds according to the embodiment described with reference to FIG. 6.

The embodiments described above are equally applicable to passive matrix electrophoretic displays that operate in either the in-plane switching mode (particles switched between being dispersed in the solvent and being held at the side electrodes), or the vertical switching mode (particles switched between a top and bottom electrode, as described above).

Furthermore, the embodiments described above are equally applicable to passively driven non-matrix displays such as segmented displays, where the segments are driven in a multiplexed manner (ie where not all segments are individually driven, but where some segments are driven in a time sequential manner from the same data driver, but are sequentially activitated by a select electrode).

In addition, whilst the above description of the invention focus upon pixel structures with only 2 electrodes per pixel, the invention is equally applicable to pixel structures where additional electrodes are introduced to the pixel to either enhance or prohibit the motion of particles. As an example, in an in-plane configuration, an additional (common) electrode could be introduced as a hidden (reservoir) electrode where particles are stored after reset. In this case, the particles in the reservoir electrode may be separated from the data electrode by a select electrode, which functions as an electrostatic barrier to prevent motion of particles from the reservoir electrode to the data electrode in all but the selected line of pixels.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. An electrophoretic display device (1) comprising an electrophoretic material comprising charged particles (16) in a fluid (5), a plurality of sets of picture elements (2), first and second electrodes (3,4) associated with each picture element (2), the charged particles (6) being able to occupy a position being one of a plurality of positions between said electrodes (3,4), said positions corresponding to respective optical states including at least first and second extreme optical states, the device further comprising drive means arranged to supply a sequence of drive signals (D) to said electrodes (3,4), each drive signal (D) causing said particles (6) to occupy a predetermined optical state corresponding to image information to be displayed, the device further comprising means for updating an image displayed on said device by:
(a) substantially simultaneously applying a reset signal (R1) to each of a plurality of said sets of picture elements (2), each reset signal (R1) causing said particles (6) to occupy one of said extreme optical states;
(b) sequentially selecting one or more picture elements (2) of said sets of picture elements to which a reset signal (R1) has been applied, and applying thereto a drive signal (D).

2. A device (1) according to claim 1, wherein said device is passively driven.

3. A device (1) according to claim 1, comprising a passive matrix device.

4. A device (1) according to claim 1, wherein a reset signal (R1) is substantially simultaneously applied to all of the sets of picture elements (2).

5. An electrophoretic display device (1) comprising an electrophoretic material comprising charged particles (6) in a fluid (5), a plurality of sets of picture elements (2), first and second electrodes (3,4) associated with each picture element (2), the charged particles (6) being able to occupy a position being one of a plurality of positions between said electrodes (3,4), said positions corresponding to respective optical states including at least first and second extreme optical states, the device further comprising drive means arranged to supply a sequence of drive signals (D) to said electrodes (3,4), each drive signal (D) causing said particles (6) to occupy a predetermined optical state corresponding to image information to be displayed, and select means for applying a select signal (S) to a set of picture elements (2) to which said drive signals (D) are to be applied, wherein, in order to update an image displayed on said device (1), said select means is further arranged to apply a reset signal (Rn) to one or more of said sets of picture elements (2) prior to applying a respective select signal (S) thereto, each reset signal (Rn) causing said particles (6) to occupy one of said extreme optical states.

6. A device (1) according to claim 5, wherein at least a subset (M) of picture elements (2) is reset substantially simultaneously, following which, the reset sets of picture elements (2) are sequentially selected.

7. A device (1) according to claim 5, wherein a reset signal (Rn) and select signal (S) are sequentially applied to each set of picture elements (2), with drive signals (D) being sequentially applied to each respective set of picture elements (2) to which a select signal (S) has been applied whilst a reset signal (Rn) is being applied to the other sets of picture elements (2) in the sequence.

8. A device (1) according to claim 1, wherein the reset signal (R1,Rn) comprises a voltage which is at least substantially equal to the highest voltage achievable across a respective picture element (2).

9. A device (1) according to claim 8, wherein the reset voltage is at least substantially equal to the voltage difference between a drive signal (D) and a select signal (S).

10. A device (1) according to claim 1, wherein each reset signal (R1,Rn) causes said particles (6) to occupy the same extreme optical state in respect of all of the picture elements (2) of the display (1).

11. A device (1) according to claim 1, wherein said reset signal (R1,Rn) comprises a plurality of pulses of alternately opposing polarities, so as to drive the respective picture element (2) successively between the extreme optical states.

12. A device (1) according to claim 11, wherein data and select signals (D,S) corresponding to each reset signal (R1,Rn) alternate between their maximum and minimum values.

13. A device (1) according to claim 11, wherein the final pulse (Rx) of the reset signal (R1,Rn) is longer and/or has a larger voltage than the preceding pulses of the reset signal (R1,Rn).

14. A device (1) according to claim 11, wherein the application of drive signals (D) to the display (1) is halted during application of the final pulse (Rx) of the reset signal (Rn).

15. A device (1) according to claim 1, wherein the voltage of said reset signal (R1,Rn) is greater than the maximum voltage required to drive all of said particles (6) to said extreme optical state.

16. A device (1) according to claim 1, comprising a third electrode associated with each picture element (2).

17. A device (1) according to claim 16, wherein said third electrode is arranged to prohibit motion of particles (6) in non-selected picture elements (2).

18. A method of driving an electrophoretic display device (1) comprising an electrophoretic material comprising charged particles (6) in a fluid (5) a plurality of sets of picture elements (2), first and second electrodes (3,4) associated with each picture element (2), the charged particles (6) being able to occupy a position being one of a plurality of positions between said electrodes (3,4), said positions corresponding to respective optical states including at least first and second extreme optical states, the method comprising supplying a sequence of drive signals (D) to said electrodes (3,4), each drive signal (D) causing said particles (6) to occupy a predetermined optical state corresponding to image information to be displayed, the method further comprising updating an image displayed on said device (1) by:
(a) substantially simultaneously applying a reset signal (R1) to each of a plurality of said sets of picture elements (2), each reset signal (R1) causing said particles (6) to occupy one of said extreme optical states;
(b) sequentially selecting one or more picture elements (2) of said sets of picture elements (2) to which a reset signal (R1) has been applied, and applying thereto a drive signal (D).

19. A drive means for driving an electrophoretic display device (1) according to claim 1, wherein the drive means is arranged to supply a sequence of drive signals (D) to said electrodes (3,4), each drive signal (D) causing said particles (6) to occupy a predetermined optical state corresponding to image information to be displayed and means for updating an image displayed on said device (1) by:
(a) substantially simultaneously applying a reset signal (R1) to each of a plurality of said sets of picture elements (2), each reset signal (R1) causing said particles (6) to occupy one of said extreme optical states;
(b) sequentially selecting one or more picture elements (2) of said sets of picture elements (2) to which a reset signal (R1) has been applied, and applying thereto a drive signal (D).

20. A method of driving an electrophoretic display device (1) comprising an electrophoretic material comprising charged particles (6) in a fluid (5), a plurality of sets of picture elements (2), first and second electrodes (3,4) associated with each picture element (2), the charged particles (6) being able to occupy a position being one of a plurality of positions between said electrodes (3,4), said positions corresponding to respective optical states including at least first and second extreme optical states, the method comprising supplying a sequence of drive signals (D) to said electrodes (3,4), each drive signal (D) causing said particles (6) to occupy a predetermined optical state corresponding to image information to be displayed, and applying a select waveform including a select signal (S) to a set of picture elements (2) to which said drive signals (D) are to be applied, wherein, said select waveform further includes a reset signal (Rn) to be applied to one or more of said sets of picture elements (2) prior to applying a respective select signal (S) thereto, each reset signal (Rn) causing said particles (6) to occupy one of said extreme optical states.

21. A drive means for driving an electrophoretic display device (1) according to claim 5, the drive means comprising a data driver for supplying a sequence of drive signals (D) to said electrodes (3,4), each drive signal (D) causing said particles (6) to occupy a predetermined optical state corresponding to image information to be displayed, and a select driver for applying a select waveform including a select signal (S) to a set of picture elements (2) to which said drive signals (D) are to be applied, wherein said select waveform further includes a reset signal (Rn) to be applied to one or more of said sets of picture elements (2) prior to applying a respective select signal (S) thereto, each reset signal (Rn) causing said particles (6) to occupy one of said extreme optical states.
